(19) United States
(12) Patent Application Publication
(10) Pub. No.: US 2016/0123393 A1
(43) Pub. Date: May 5, 2016

(54) BEARING CAGE AND METHOD OF FORMING A BEARING CAGE

(71) Applicant: Thomas Krause, Grafenrheinfeld (DE)

(72) Inventor: Thomas Krause, Grafenrheinfeld (DE)

(73) Assignee: Aktiebolaget SKF, Goteborg (SE)

(21) Appl. No.: 14/928,299

(22) Filed: Oct. 30, 2015

(30) Foreign Application Priority Data
Oct. 31, 2014 (DE) 10 2014 222 283.4

(51) Int. Cl. F16C 33/56; C08J 3/20; C08J 3/28; C08J 3/00; F16C 33/46; B29B 13/08

(52) U.S. Cl. CPC F16C 33/56; F16C 33/4635; B29B 13/08; C08J 3/28; C08J 3/005; C08J 3/203; B29K 2071/00

(57) ABSTRACT

A rolling-element bearing cage includes a first ring member, a second ring member, and a plurality of bridge members connecting the first ring member to the second ring member. Adjacent pairs of the plurality of bridge members define a plurality of pockets configured to receive and retain at least one rolling element. The cage includes a plastic composition, and the plastic composition includes irradiated polytetrafluoroethylene (PTFE) and a matrix plastic selected from the group consisting of polyether ether ketone (PEEK), polyamide (PA), polyphthalamide (PPA), polyetherimide (PEI), polyethersulfone (PESU), polyoxymethylene (POM), polyphenylene sulfide (PPS), polypropylene (PP), and combinations thereof.

### CROSS-REFERENCE TO RELATED APPLICATIONS

This application claims priority to German patent application no. 10 2014 222 283.4 filed on Oct. 31, 2014, the contents of which are fully incorporated herein by reference.

### TECHNOLOGICAL FIELD

The present disclosure relates to a bearing cage for a rolling-element bearing that is made at least partially of plastic and to a method of forming such a bearing cage.

### BACKGROUND

Bearing cages, in particular bearing cages made at least partially of plastic, are widely used in mechanical engineering, and they play an important role due to their potential for achieving weight reduction.

In addition to weight reduction, plastic cages also offer mechanical advantages over metal cages and may be easier to manufacture as well. Thus, for example, rolling-element bearing cages made at least partially of plastic can be self-lubricating and/or castable.

Because of its advantageous low-friction properties, polytetrafluoroethylene (PTFE) is one material that can be used in self-lubricating bearings. PTFE is characterized by a low coefficient of friction, good resistance to chemicals, and good impact resistance. However, its advantageous non-stick properties prevent PTFE from bonding well to other plastic matrices (polymer matrices), and this makes it difficult to use PTFE as a filler. Therefore, when a plastic article comprising PTFE rubs against another structure, in a rolling-element bearing, for example, PTFE particles can detach very easily from the surrounding matrix such that they no longer act as a lubricant for the plastic article. In addition, plastics (polymer matrices) that include PTFE filler powder typically exhibit a significant reduction in impact strength. This is because crack formation preferentially occurs at the poorly adhering boundary surfaces between the PTFE powder and the plastic matrix (polymer matrix).

A rolling-element bearing cage comprised of irradiated PTFE and polyamide-imide (PAI) matrix plastic is known from DE 102006030836 (a family member of US 2010/021098). Irradiating PTFE improves its ability to bond to a matrix plastic.

However, a disadvantage of using this plastic composition in bearing cages is that PAI exhibits brittle behavior immediately after shaping, and it therefore must be tempered for a long time at high temperatures before use. In medium and heavy machine construction, for example, in the motor vehicle industry, high demands are placed on the bearing material with respect to loadability and tribological properties. In this field, limits are therefore placed on bearing cages manufactured from PAI, because the necessary tempering step would take too long and cost too much, in part because of the large dimensions of the bearing elements being tempered.

### SUMMARY

A first aspect of the present disclosure is therefore to provide a bearing cage for a rolling-element bearing, in particular a rolling-element bearing usable in motor vehicles, that has improved mechanical and/or tribological properties.

In one aspect of the present disclosure a bearing cage is provided for a rolling-element bearing and is made at least partially from a plastic composition (polymer matrix). In order to provide improved mechanical and tribological properties, the plastic composition comprises irradiated polytetrafluoroethylene (PTFE) as well as a matrix plastic made from polyether ether ketone (PEEK), polyamide (PA), polyphthalamide (PPA), polyetherimide (PEI), polyethersulfone (PESU), polyoxymethylene (POM), polyphenylene sulfide (PPS), polypropylene (PP), or combinations thereof.

The matrix plastic PEEK is characterized by having high strength and hardness. In addition, PEEK also has very good frictional and sliding properties and a high abrasion resistance. The inventors have surprisingly found that irradiated PTFE can bond (bind) very well to PEEK while maintaining the advantageous properties of PTFE and PEEK. The plastic composition made of irradiated PTFE and PEEK is characterized by improved temperature and chemical resistance, better impact resistance and elongation at break, and by a low coefficient of friction and low wear. Furthermore, due to the low brittleness of the plastic composition, the tempering step previously required before irradiated PTFE-containing plastics could be used is not required. Analogous results have been shown for the matrix plastics PA, PPA, PEI, PESU, POM, PPS, and PP.

The reason for this improved bonding (binding) of irradiated PTFE is that functional groups are generated/created during the radiation treatment, via which the otherwise bonding-resistant PTFE can be at least partially chemically and/or physically bonded (bound) to the matrix plastic. The chemical and/or physical bonding of PTFE to the matrix plastic can be effected, for example, via covalent bonds, electrostatic bonds, hydrogen bridge bonds, van der

Waals bonds (interactions), and/or hydrophobic interactions. In particular, surface-activated PTFE includes acyl fluoride groups (—COF groups), carboxylic acid groups (—COOH groups) and/or perfluoroalkyl groups, which can at least partially bond (bind) to the matrix plastic by, for example, a covalent acyl bond or by a hydrogen bridge bond.

This particularly strong bonding (binding) of the irradiated PTFE to the matrix plastic gives bearing cages formed of such materials a high mechanical and thermal loadability and a longer service life. Thus bearing cages disclosed herein are particularly well suited to handle the high speeds and high weight loads that occur in the motor vehicle industry.

The irradiation of PTFE is preferably effected by electron irradiation. In general, however, any other type of surface activation of PTFE is possible. The electron irradiation of PTFE is preferably effected using a dose, measured in kilograys (kGy), of 300-900 kGy, preferably 500-700 kGy.

According to a preferred exemplary embodiment the bearing cage includes a proportion of irradiated PTFE in the plastic composition of 1 to 80 percent by mass, preferably 5 to 60 percent by mass and particularly preferably 10 to 30 percent by mass with respect to the total mass of the plastic composition.

With these proportions particularly advantageous tribological properties of the bearing cage are achieved, namely, good lubrication with low friction and low wear, while the proportion of the matrix plastic simultaneously ensures a high resistance to heat-induced warping and provides mechanical stability.

According to a further advantageous exemplary embodiment the irradiated PTFE in the plastic composition is in particle form. Preferably the irradiated PTFE has a mean particle size d₅₀ of less than or equal to 150 μm, preferably less than or equal to 100 μm, and particularly preferably less than or equal to 50 μm. In these embodiments there is a particularly favorable overall surface of the irradiated PTFE particles in the plastic composition, and advantageous tribological and mechanical properties of the bearing cage are achieved. Essentially, there is no lower limit for the size of the irradiated PTFE particles as long as particle agglomeration does not occur and the particles remain able to bond (bind) well to the matrix plastic.

Advantageously PTFE is at least 30%, at least 50%, at least 70%, or at least 90% comprised of a PTFE recyclate or is entirely comprised of a PTFE recyclate. The use of recycled PTFE powder reduces costs and also helps protect the environment. This is because perfluorocarbons may be released into the environment during the manufacture or disposal of PTFE, and may be hazardous to health. Such releases are reduced when PTFE is recycled.

In another embodiment the plastic composition additionally includes reinforcing fibers. Suitable reinforcing fibers include, for example, glass fibers, carbon fibers, and combinations of these fiber materials. In this way the mechanical stability of the disclosed bearing cage can advantageously be increased in order to, for example, provide highly loadable wheel bearings for the motor vehicle industry.

Another aspect of the disclosure relates to a rolling-element bearing comprising a bearing cage at least partially made of plastic (polymer) as described above. Such rolling-element bearings can be advantageously used in all areas of mechanical engineering. It is possible to use the disclosed rolling-element bearings in motor vehicle manufacturing, for example, as wheel bearings. In particular, the rolling-element bearing can be used as a wheel bearing in rail vehicles, for example high-speed trains.

A further aspect of the disclosure relates to a method for manufacturing a bearing cage according to the previously-mentioned embodiments, in particular for a wheel bearing, characterized in that the method comprises the following steps:
a) irradiate the PTFE,
b) compound the irradiated PTFE with a matrix plastic, wherein the matrix plastic comprises PEEK, PA, PPA, PEI, PESU, POM, PPS, PP, or combinations thereof, and
c) form a bearing cage of the compound including the irradiated PTFE.

Due to the matrix plastics chosen, a thermal post-treatment, for example, by tempering, is not required. The bearing cage is thus usable, for example, in a rolling-element bearing, immediately after its formation. This results in reduced production time and cost.

The irradiation can be performed in the presence of a reactive gas, such as air or oxygen. An absorber material can also be present during the irradiation in order to bond with the aggressive hydrogen fluoride that results from irradiation. Activated carbon, for example, is a suitable absorber material. Other suitable absorber materials are known in the art.

In one advantageous embodiment the method further comprises grinding PTFE, such as PTFE recyclate. Although the grinding can occur before or after irradiating the PTFE, the grinding of the PTFE is preferably performed after the irradiating.

Furthermore, a fibrous material, for example, carbon fibers and/or glass fibers, can be added during compounding of the irradiated PTFE and the matrix plastic to increase the structural stability.

The disclosure is described in greater detail below with reference to an exemplary embodiment depicted in the Figure. The exemplary embodiment is purely exemplary in nature and is not intended to define the scope of the application. This scope is defined solely by the patent claims.

### BRIEF DESCRIPTION OF THE DRAWINGS

These and other aspects and features of the disclosure will be better understood after a review of the following detailed description together with the attached drawings.

FIG. 1 is a schematic elevational view of a portion of a bearing cage according to the disclosure.

FIG. 2 is a flowchart of a preferred exemplary embodiment of the disclosed method.

### DETAILED DESCRIPTION

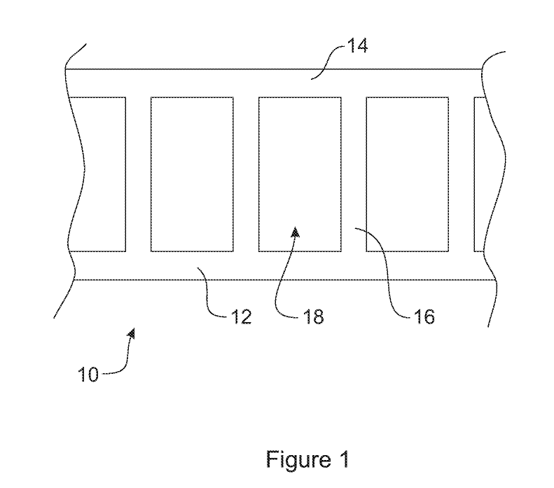

FIG. 1 illustrates a bearing cage 10 that can be formed according to the teachings of the present disclosure. The bearing cage 10 includes a first ring member 12, a second ring member 14 and a plurality of bridge members 16 connecting the first ring member 12 to the second ring member 14. Adjacent pairs of the plurality of bridge members 16 define a plurality of pockets 18 for receiving and retaining roller elements (not illustrated).

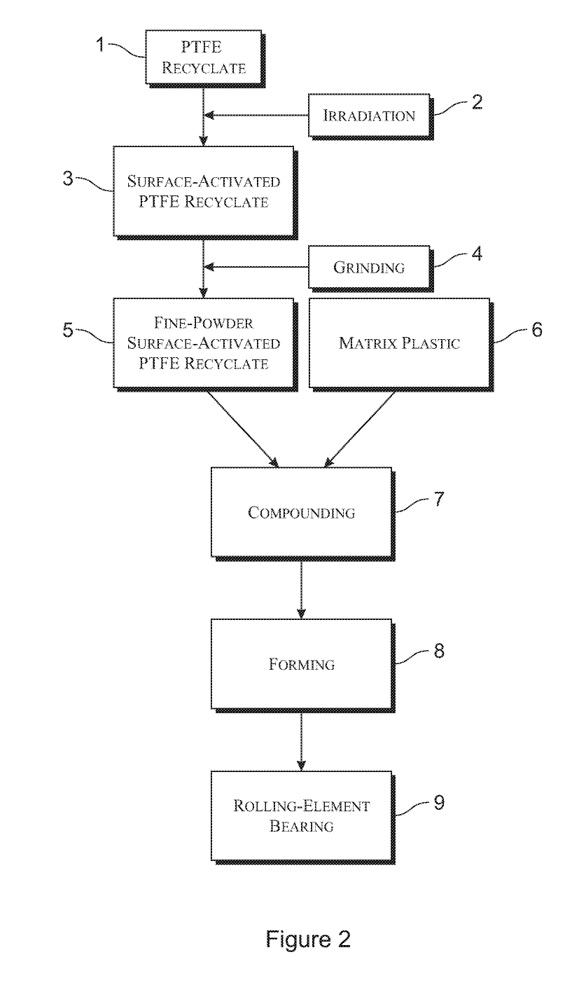

FIG. 2 is a flowchart of a preferred exemplary embodiment of a method for manufacturing a bearing cage from irradiated PTFE and a matrix plastic. In a first step 1, PTFE is provided. It is particularly advantageous here to use a PTFE recyclate that is a secondary material, for example, unmixed pre-ground millings and shavings from machining operations. Of course it is also possible to use a PTFE recyclate mixed with newly made PTFE or to entirely use newly made PTFE, such as, for example, Dyneon™ TF 2025 available from 3M.

In a second step 2, the PTFE recyclate is surface-activated by surface treatment, in particular electron irradiation. The radiation dose is preferably approximately 500 kGy. The irradiation takes place in the presence of a reactive gas, such as, for example, oxygen. An absorber material, such as, for example activated carbon, can additionally be used to bond the aggressive hydrogen fluoride produced by the irradiation. As a result of the irradiation, the surface-activated PTFE recyclate includes acyl fluoride groups (—COF groups), carboxylic acid groups (—COOH groups) and/or perfluoroalkyl groups, which can form bonds, for example, covalent acyl bonds or hydrogen bridge bonds.

Due to the irradiation in step 2, surface-activated PTFE is provided in powder form for subsequent processing. The mean size d₅₀ of the particles decreases with increasing radiation dose. However, since the PTFE recyclate, in contrast to newly made PTFE, does not disintegrate into fine powder, or insufficiently disintegrates into fine powder, in step 4 the surface-activated

PTFE is crushed in a grinding step in order to provide a finely-powderized, surface-activated PTFE recyclate (see reference number 5). The grinding is effected in appropriate mills, which are known in the art, such as speed rotor mills. Thereafter the mean particle size of the PTFE recyclate is reduced to the range of d₅₀=30-100 μm. However, it is generally possible to crush the particles further as long as no agglomeration of the particles occurs.

In order to produce a bearing cage made from irradiated PTFE and a matrix plastic, a matrix plastic, for example, PEEK, is provided in step 6. The matrix plastic additionally includes reinforcing fibers, for example, glass fibers and/or carbon fibers. The pulverized surface-activated PTFE recyclate is subsequently compounded with the matrix plastic (step 7). The compounding of the plastic compound is preferably effected by admixing the irradiated PTFE recyclate powder in a proportion of 30 percent by mass with respect to the total mass of the plastic composition.

The compounding itself can be effected in an extruder. Here chemical and or physical bonding (binding) of the irradiated PTFE recyclate with the matrix plastic occurs due to the formation of covalent acyl bonds and non-covalent hydrogen bridge bonds. In other matrix plastics, such as polyamides, direct amide bonds (PTFE-CO—NH—PA) can also be formed.

After the compounding, in step 8 the bearing cage is formed by an injection-molding process. A particularly simple and design-flexible shaping is thereby ensured.

A thermal post-treatment, such as, for example, a tempering step, of a bearing cage manufactured in this manner is not required. This saves time and money.

After hardening, the bearing cage can be incorporated (installed) into a rolling-element bearing (step 9).

Due to its plastic composition, the disclosed bearing cage has a particularly high resistance to chemicals and is thus suited for use in combination with lubricating greases including extreme pressure (EP) additives. At the same time, the bearing cage has a high mechanical stability and heat resistance/high dimensional stability when heated. Due to this advantageous combination of properties, the bearing cage is suitable, for example, for a use in a railway wheel set bearing.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing cages.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A rolling-element bearing cage comprising:
a first ring member;
a second ring member; and
a plurality of bridge members connecting the first ring member to the second ring member, adjacent pairs of the plurality of bridge members defining a plurality of pockets configured to receive and retain at least one rolling element,
wherein the rolling-element bearing cage includes a plastic composition, the plastic composition including irradiated polytetrafluoroethylene (PTFE) and a matrix plastic, the matrix plastic being selected from the group consisting of polyether ether ketone (PEEK), polyamide (PA), polyphthalamide (PPA), polyetherimide (PEI), polyethersulfone (PESU), polyoxymethylene (POM), polyphenylene sulfide (PPS), polypropylene (PP), and combinations thereof.

2. The bearing cage according to claim 1, wherein the irradiated PTFE comprises PTFE having functional groups selected from the group consisting of: acyl fluoride groups, carboxylic acid groups, perfluoroalkyl groups and combinations thereof.

3. The bearing cage according to claim 1, wherein the irradiated PTFE comprises electron-irradiated PTFE that has been irradiated with a dose between 500 and 700 kGy.

4. The bearing cage according to claim 1, wherein the PTFE comprises 1-80 mass % of the total mass of the plastic composition.

5. The bearing cage according to claim 1, wherein the PTFE comprises 10-30 mass % of the total mass of the plastic composition.

6. The bearing cage according to claim 1, wherein the PTFE is in particle form and has a mean particle size d₅₀ of less than or equal to 150 μm.

7. The bearing cage according to claim 1, wherein the PTFE is in particle form and has a mean particle size d₅₀ of less than or equal to 100 μm.

8. The bearing cage according to claim 1, wherein the PTFE is in particle form and has a mean particle size d₅₀ of less than or equal to 50 μm.

9. The bearing cage according to claim 1, wherein the PTFE comprises a PTFE recyclate.

10. The bearing cage according to claim 1, wherein the matrix plastic includes reinforcing fibers.

11. The bearing cage according to claim 1, wherein the matrix plastic includes glass and/or carbon reinforcing fibers.

12. The bearing cage according to claim 1, wherein the rolling-element bearing is a wheel bearing.

13. The bearing cage according to claim 1,
wherein the irradiated PTFE comprises electron-irradiated PTFE that has been irradiated at a dose greater than 500-700 kGy,
wherein the PTFE comprises 10-30 mass % of the total mass of the plastic composition,
wherein the PTFE is in particle form and has a mean particle size d₅₀ of less than or equal to 50 μm,
wherein the PTFE comprises a PTFE recyclate, and
wherein the matrix plastic includes glass and/or carbon reinforcing fibers.

14. The bearing cage according to claim 1, wherein the matrix plastic comprises PEEK.

15. A method for manufacturing a bearing cage for a wheel bearing comprising:
a) irradiating polytetrafluoroethylene (PTFE);
b) compounding the irradiated PTFE and a matrix plastic selected from the group consisting of polyether ether ketone (PEEK), polyamide (PA), polyphthalamide (PPA), polyetherimide (PEI), polyethersulfone (PESU), polyoxymethylene (POM), polyphenylene sulfide (PPS), polypropylene (PP), and combinations thereof; and
c) forming a bearing cage from the compounded irradiated PTFE and matrix plastic.

16. The method according to claim 15, wherein irradiating the PTFE comprises irradiating the PTFE in the presence of a reactive gas.

17. The method according to claim 16, wherein the reactive gas is oxygen.

18. The method according to claim 15, further comprising grinding the irradiated PTFE prior to step b).

19. The method according to claim 15, including adding carbon and/or glass fibers to the plastic composition.

20. The method according to claim 15, wherein irradiating the PTFE comprise irradiating the PTFE with a dose between 500 and 700 kGy.
